(19) United States
(12) Patent Application Publication
(10) Pub. No.: US 2022/0029366 A1
(43) Pub. Date: Jan. 27, 2022

(54) COMPUTER MODULE PLUGIN CONVERSION SYSTEMS AND RELATED METHODS

(71) Applicant: Promethean Limited, Blackburn (GB)

(72) Inventors: Robert Cross, Atlanta, GA (US); Paul Wareing, Catterall (GB); John Brannan, Bolton (GB)

(73) Assignee: Promethean Limited, Blackburn (GB)

(21) Appl. No.: 17/386,090

(22) Filed: Jul. 27, 2021

Related U.S. Application Data
(60) Provisional application No. 63/057,021, filed on Jul. 27, 2020.

(51) Int. Cl. H01R 24/60; H01R 24/68

(52) U.S. Cl. CPC H01R 24/60; H01R 24/68; H01R 2103/00; H01R 2201/18; H01R 2201/06

(57) ABSTRACT

A pluggable module is configured for providing a second connector type to a display device that lacks the second connector type via an available pluggable computing module slot. The pluggable module comprises: (1) a housing dimensioned to correspond to pluggable computing module slot; (2) a first connector of a first connector type configured to engage with a corresponding connector disposed in the computing module plug-in slot; and (3) a second connector of the second connector type such that the second connector is configured to enable a user to plug a cable that corresponds to the second connector type into the second connector to facilitate a direct connection between the pluggable module and a connected computing device via the cable.

### CROSS-REFERENCE TO RELATED APPLICATIONS

This application claims priority from U.S. Provisional Patent Application Ser. No. 63/057,021, filed Jul. 27, 2020, which is hereby incorporated herein by reference in its entirety.

### BACKGROUND

Users of interactive displays or other display devices may desire a streamlined, unified experience, particularly when utilizing one or more connected devices through a single display. Accordingly, there is a need for systems and methods that address these desires.

### SUMMARY

In particular embodiments, a pluggable module for converting a first connector type to a second connector type, the pluggable module comprises: (1) a housing dimensioned to correspond to a computing module plug-in slot of a display device; (2) a first connector of the first connector type disposed on the housing and configured to engage with a corresponding connector disposed in the computing module plug-in slot, wherein the first connector has a first set of pins according to the first connector type; (3) a second connector of the second connector type disposed on the housing such that when the pluggable module is inserted into the computing module plug-in slot of the display device, the second connector is accessible and configured to enable a user to plug a cable that corresponds to the second connector type into the second connector to facilitate a direct connection between the pluggable module and a connected computing device via the cable, wherein the second connector has a second set of pins according to the second connector type; and (4) circuitry configured to map the first set of pins to the second set of pins.

In any embodiment described herein, the computing module plug-in slot may include, for example, any standard format computing module plug-in slot such as: (1) Open Pluggable Specification (OPS); (2) Smart Display Module (SDM); (3) Open Pluggable Specification Plus (OPS+); and/or (4) Open Pluggable Specification-China (OPS-C). In various embodiments, the housing has a standard slottable computing module geometry that corresponds to a slottable computing module geometry such as, for example: (1) Open Pluggable Specification (OPS); (2) Smart Display Module (SDM); (3) Open Pluggable Specification Plus (OPS+); and (4) Open Pluggable Specification-China (OPS-C). In various embodiments, pluggable module does not provide computer functionality to the display device when inserted into the computing module plug-in slot of the display device.

In particular embodiments, the circuitry maps at least one first pin from the first connector to at least one second pin of the second connector. In various embodiments, the circuitry is configured to transfer power between the at least one first pin and the at least on second pin such that the circuitry provides power a connected computing device connected to the pluggable module via the second connector. In one or more embodiments, the circuitry is configured to transfer one or more pieces of data between the first connector and the second connector, the one or more pieces of data including one or more pieces such as: (1) video data; (2) audio data; (3) network data; (4) USB data; (5) etc. In various embodiments, the second connector may be a USB-C connector; and/or a thunderbolt connector. In a particular embodiment, the first connector may include an OPS 80-PIN connector or a PCI-e connector.

A pluggable converter module, according to various embodiments, is configured for converting a first connector type into a second connector type. In any embodiment described herein, the pluggable module comprises: (1) a housing dimensioned to correspond to a computing module plug-in slot of an interactive touch display device; (2) a first connector of the first connector type disposed on the housing and configured to engage with a corresponding connector disposed in the computing module plug-in slot of the interactive touch display device, wherein the first connector has a first set of pins according to the first connector type; (3) a second connector of the second connector type disposed on the housing such that when the pluggable module is inserted into the computing module plug-in slot of the interactive touch display device, the second connector is accessible and configured to enable a user to plug a cable that corresponds to the second connector type into the second connector to facilitate a direct connection between the pluggable module and a connected computing device via the cable, wherein the second connector has a second set of pins according to the second connector type; and (4) circuitry configured to map the first set of pins to the second set of pins, wherein the pluggable converter module is configured to pass video, sound, power, and USB signals between the first connector type and the second connector type.

In various embodiments, the circuitry defines a high-speed data path between the first set of pins and the second set of pins. In any embodiment described herein, the high-speed data path comprises a universal serial bus. In some embodiments, the pluggable convertor module comprises a controller configured to detect a power requirement for the connected computing device. In various embodiments, the pluggable converter module is configured to pass power from the interactive display device to the connected computing device based on the power requirement.

In particular embodiments, the pluggable convertor comprises integrated circuit configured to detect a power down of the interactive touch display device and, in response to detecting the power down, initiating a power down of the connected computing device according to a safe power down protocol. In various embodiments, the second connector type is one of a USB-C connector and a thunderbolt connector.

A method of connecting an interactive display device to a connected computing device via a cable corresponding to a connector type that the interactive display device does not comprise, in various embodiments, comprises: (A) providing an interactive display device defining a computing module plug-in slot dimensioned to receive a computing module plug-in of a first type and comprising a computing module plug-in slot connector disposed in the computing module plug-in slot; (B) proving a pluggable module having a geometry that corresponds to the computing module plug-in of the first type and comprising: (1) a first pluggable module connector that corresponds to the computing module plug-in slot connector and is disposed on a first side of the pluggable module; (2) a second pluggable module connector of the connector type disposed on a second side of the pluggable module, the second side of the pluggable module opposing the first side of the pluggable module; and (3) circuitry that maps the first pluggable module connector to the second pluggable module connector such that the circuitry is configured to transmit video data, audio data, network data, power, and USB data between the first pluggable module connector and the second pluggable module connector; (C) slotting the pluggable module into the computing module plug-in slot such that the first side of the pluggable module enters the computing module plug-in slot first and the computing module plug-in slot connector engages with the first pluggable module connector; (D) providing the cable corresponding to the connector type; and € directly connecting the connecting computing device to the interactive display device by directly connecting the connected computing device to the second pluggable module connector using the cable such that the video data, audio data, network data, power, and USB data pass from the connecting computing device to the interactive display device by via the pluggable module and the cable.

In a particular embodiment, the cable comprises a USB-C cable, the second pluggable module connector comprises a USB-C connector, the computing module plug-in of the first type comprises Open Pluggable Specification, the computing module plug-in slot connector comprises an OPS 80-PIN connector; and the first pluggable module connector comprises a corresponding OPS 80-PIN connector. In some embodiments, the circuitry maps at least one first pin from the first pluggable module connector to at least one second pin of the second pluggable module connector. In any embodiment described herein, the circuitry is configured to transfer at least one of the video data, the audio data, the network data, the power, and the USB data between the at least one first pin and the at least on second pin such that the circuitry provides a direct connection between the connected computing device and the interactive display device.

### BRIEF DESCRIPTION OF THE DRAWINGS

Various embodiments of an interactive display system are described below. In the course of this description, reference will be made to the accompanying drawings, which are not necessarily drawn to scale, and wherein:

FIG. 1 is a block diagram of an interactive display system in accordance with an embodiment of the present system.

FIG. 2 is a block diagram of an interactive display system in accordance with a particular embodiment of the present system.

FIG. 3 is a block diagram of an interactive display system in accordance with a particular embodiment of the present system.

FIG. 4 is a schematic diagram of a computer, such as the One or More Interactive Display Devices 110 (e.g., Interactive Display Device) or the One or More Connected Computing Devices 120 of FIG. 1, that is suitable for use in various embodiments.

### DETAILED DESCRIPTION

Various embodiments now will be described more fully hereinafter with reference to the accompanying drawings. It should be understood that the invention may be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

### Overview

An Interactive Display System 100, according to particular embodiments, comprises: (1) One or More Interactive Display Devices 110, which may, for example, include any suitable interactive display device (e.g., such as any suitable Promethean ActivPanel display); and (2) One or More Connected Computing Devices 120 operatively coupled to the One or More Interactive Display Devices 110 (e.g., via any suitable connection). In some embodiments, the One or More Interactive Display Devices 110 are configured to pass data (e.g., video data, audio data, network data, input data, USB data, etc.) to the One or More Connected Computing Devices 120 and receive data (e.g., video data, audio data, network data, input data, USB data, etc.) from the One or More Connected Computing Devices 120 via any suitable connection. In particular embodiments, the One or More Interactive Display Deices 110 comprise at least one Computing Module Plug-In Slot 150 configured to receive any suitable computing module plug-in. In various embodiments, the computing module plug-in may comprise any suitable plug-in configured to add computing capability to flat panel displays and other display devices. In particular embodiments a computing module plug-in may include, for example, any suitable format computing module plug-in such as: (1) Open Pluggable Specification (OPS); (2) Smart Display Module (SDM); (3) Open Pluggable Specification Plus (OPS+); (4) Open Pluggable Specification-China (OPS-C); and/or (5) any other suitable format computing module plug-in. As may be understood in light of this disclosure, a computing module plug-in may have a form factor that corresponds to a form factor of the Computing Module Plug-In Slot 150 such that the computing module plug-in is configured to slot into the Computing Module Plug-In Slot 150 and engage with the Interactive Display Device 110 (e.g., or other display device) via a suitable connector in order to transfer data (e.g., any suitable data described herein) between the computing module plug-in and the Interactive Display Device 110 and/or provide computing functionality to the Interactive Display Device 110.

In various embodiments, an Interactive Display Device 110 may comprise any suitable connection receptacle(s) such as, for example: (1) any suitable USB connector (e.g., USB-A, USB-B, Mini-USB, Micro-USB, USB-C, etc.); (2) any suitable video connector (e.g., s-video, component, VGA, DVI HDMI, DisplayPort, USB-C, etc.); (3) any suitable network connector (e.g., RJ45, etc.); and/or (4) any other suitable connection receptacle or device for connecting to any suitable external device (e.g., the One or More Connected Computing Devices 120), network, etc.). In various embodiments, the one or more suitable connection receptacle(s) may be integrated into the Interactive Display Device in order to enable a substantially direct connection between the Interactive Display Device 110 and any external device (e.g., the One or More Connected Computing Devices 120).

In particular embodiments, a particular Interactive Display Device 110 may lack a particular desired connector type. In some embodiments, the Interactive Display Device 110 may, for example, have been manufactured prior to a standardization of a more recently developed connector type. In other embodiments, the Interactive Display Device 110 may, for example, not have been designed to include the particular connector type. In still other embodiments, the Interactive Display Device 110 may have an insufficient number of available connectors of the desired type. In various embodiments, the Interactive Display Device 110 may lack the desired connector type for any other suitable reason. For example, many recently designed computing devices comprise at least one USB-C connection, while many legacy display devices (e.g., digital signage or other display devices) may lack a USB-C connection, while including at least one computing module plug-ins such as an OPS or other suitable computing module plug-in. For such devices, it may be desirable to provide a USB-C input via a pluggable module such that the legacy display device may be connected to a connected computing device directly via a single cable (e.g., USB-C).

As will be described more fully herein, it may be desirable to leverage an available Computing Module Plug-In Slot 150 on an Interactive Display Device 110 in order to provide an additional connector type in order to facilitate a direct connection to a Connected Computing Device 120. In this way, an Interactive Display System 100 may be configured to provide computing capability (e.g., or additional computing capability) to an Interactive Display Device 110 via a Connected Computing Device 120 coupled to the Interactive Display Device 110 via a Pluggable Module 130 (e.g., rather than via from a computing module plug-in). In particular embodiments, the Pluggable Module 130 may be configured to: (1) slot into the Computing Module Plug-In Slot 150; (2) engage with a Computing Module Plug-In Slot Connector 154 (e.g., via a First Pluggable Module Connector 134); (3) convert and transmit data and/or power between the Computing Module Plug-In Slot Connector 154 and a Second Pluggable Module Connector 132 (e.g., by mapping one or more pins of the Computing Module Plug-In Slot Connector 154 to the Second Pluggable Module Connector 132); and (4) make power and/or data transmission available between the Second Pluggable Module Connector 132 and a Connected Computing Device 120 (e.g., via a Cable 180), the power and/or data having been received from the Computing Module Plug-In Slot Connector 154.

Pluggable Module for Converting a Computing Module Plug-In Slot Connector to a Desired Connector Type

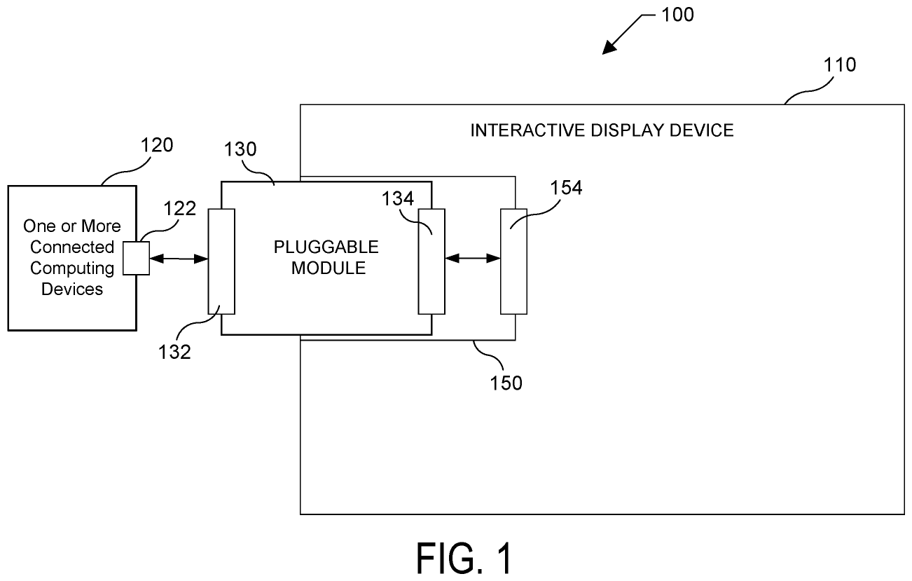

FIG. 1 depicts a block diagram of an Interactive Display System 100 according to a particular embodiment. In the embodiment shown in this Figure, the Interactive Display System 100 comprises: (1) One or More Interactive Display Devices 110; (2) a Pluggable Module 130 (e.g., One or More Pluggable Modules 130; and (3) One or More Connected Computing Devices 120. In the course of this disclosure, references to an Interactive Display Device 110 should be understood to encompass a plurality of interactive display devices (e.g., the One or More Interactive Display Devices 110). Similarly, references to a Connected Computing Device 120 should be understood to encompass a plurality of connected computing devices (e.g., the One or More Connected Computing Devices 120). Still other references to a Pluggable Module 130 should be understood to encompass embodiments in which the Interactive Display System 100 comprises One or more Pluggable Modules 130 (e.g., such as embodiments in which the Interactive Display Devices 110 comprises a plurality of Computing Module Plug-In Slots 150).

Interactive Display Device

In various embodiments of an Interactive Display System 100, the Interactive Display Device 110 comprises one or more touch screen display devices, which may, for example, comprise any suitable touch screen device configured to receive input via contact on the display device (e.g., via a user's finger or other body part, via a stylus or other pen-like device, etc.). In such embodiments, the Interactive Display Device 110 may comprise any suitable input device. For example, in various embodiments, the Interactive Display Device 110 comprises one or more resistive touch screen displays (e.g., one or more 5-wire resistive touch screen displays), one or more surface capacitive touch screen displays, one or more projected capacitive touch screen displays, one or more surface acoustic wave touch screen displays, one or more infrared touch screen displays (e.g., which may, for example include one or more touch overlays at least partially embedded in a bezel of the Interactive Display Device 110), or any other suitable touch screen display. In particular embodiments, the Interactive Display Device 110 comprises one or more processors and memory. In such embodiments, the Interactive Display Device 110 may comprise stand-alone computing devices such as handheld computing device (e.g., tablet computers or smartphones), wall mounted display devices (e.g., such as touch-enabled computerized LED and/or LCD displays), etc. In other embodiments, the Interactive Display Device 110 may include any suitable ‘dumb’ interactive display device, which may, for example, primarily be configured to display information from and provide input for a at least one connected computing device (e.g., one or more computing module plug-ins such as an OPS or other suitable computing module plug-in, one or more substantially directly Connected Computing Devices 120, etc.). In various embodiments, the Interactive Display Device 110 may comprise any suitable device comprising a display screen and an input device operatively coupled to the Interactive Display Device 110. In still other embodiments, the Interactive Display Device 110 may include any suitable digital signage system.

In particular embodiments, the Interactive Display Device 110 is configured to detect a plurality of simultaneous inputs (e.g., from a plurality of users). In various embodiments, the Interactive Display Device 110 may be configured to enable a user to interact with one or more displayed images as the user would interact with any other computing display device (e.g., by drawing on the one or more projected images, operating a browser, playing a video, etc.), etc. In still other embodiments, the Interactive Display Device 110 may include one or more computing components (e.g., one or more processors and memory) such that the Interactive Display Device 110 each embodies a stand-alone computing device (e.g., that is configured to perform one or more computing functions).

In particular embodiments, the Interactive Display Device 110 is configured to run software locally on the Interactive Display Device 110. For example, in one embodiment of an Interactive Display System 100, the Interactive Display Device 110 may store software applications on local memory associated with the Interactive Display Device 110.

In particular embodiments, the Interactive Display Device 110 comprises a Computing Module Plug-In Slot 150. In various embodiments, the Computing Module Plug-In Slot 150 is dimensioned to accept a computing module plug-in having a particular form factor (e.g.: (1) Open Pluggable Specification (OPS); (2) Smart Display Module (SDM); (3) Open Pluggable Specification Plus (OPS+); (4) Open Pluggable Specification-China (OPS-C); and/or (5) any other suitable format computing module plug-in). In various embodiments, the Computing Module Plug-In Slot 150 comprises a Computing Module Plug-In Slot Connector 154. In various embodiments, the Computing Module Plug-In Slot Connector 154 is configured to provide a connection between the Interactive Display Device 110 and a computing module plug-in that has been slotted into the Computing Module Plug-In Slot 150. In any embodiment described herein, the Computing Module Plug-In Slot Connector 154 may comprise, for example, any suitable connector such as: (1) an 80 PIN OPS connector (e.g., a JAE TX25 plug connector and/or TX 24 receptacle or other suitable JAE connector type); (2) a PCI and/or PCI-e connector; and/or (3) any other suitable connector).

In particular embodiments, a particular Interactive Display Device 110 may lack a particular desired connector type. In some embodiments, the Interactive Display Device 110 may, for example, have been manufactured prior to a standardization of a more recently developed connector type. In other embodiments, the Interactive Display Device 110 may, for example, not have been designed to include the particular connector type. In still other embodiments, the Interactive Display Device 110 may have an insufficient number of available connectors of the desired type. In various embodiments, the Interactive Display Device 110 may lack the desired connector type for any other suitable reason. For example, many recently designed computing devices comprise at least one USB-C connection, while many legacy display devices (e.g., digital signage or other display devices) may lack a USB-C connection, while including at least one computing module plug-ins such as an OPS or other suitable computing module plug-in. For such devices, it may be desirable to provide a USB-C input via a pluggable module such that the legacy display device may be connected to a connected computing device directly via a single cable (e.g., USB-C).

As will be described more fully herein, it may be desirable to leverage an available Computing Module Plug-In Slot 150 on an Interactive Display Device 110 in order to provide an additional connector type in order to facilitate a direct connection to a Connected Computing Device 120. In this way, an Interactive Display System 100 may be configured to provide computing capability (e.g., or additional computing capability) to an Interactive Display Device 110 via a Connected Computing Device 120 coupled to the Interactive Display Device 110 via a Pluggable Module 130 (e.g., rather than via from a computing module plug-in). In particular embodiments, the Pluggable Module 130 may be configured to: (1) slot into the Computing Module Plug-In Slot 150; (2) engage with a Computing Module Plug-In Slot Connector 154 (e.g., via a First Pluggable Module Connector 134); (3) convert and transmit data and/or power between the Computing Module Plug-In Slot Connector 154 and a Second Pluggable Module Connector 132 (e.g., by mapping one or more pins of the Computing Module Plug-In Slot Connector 154 to the Second Pluggable Module Connector 132); and (4) make power and/or data transmission available between the Second Pluggable Module Connector 132 and a Connected Computing Device 120 (e.g., via a Cable 180), the power and/or data having been received from the Computing Module Plug-In Slot Connector 154.

One or More Connected Computing Devices

In particular embodiments, the One or More Connected Computing Devices 120 may include any suitable connected computing device such as, for example, one or more laptop computers, one or more tablet computers, one or more Chrome boxes, one or more Amazon Fire TV devices, one or more Apple TV devices, one or more gaming systems (e.g., one or more Microsoft, Sony, Nintendo, etc. gaming systems), or any other suitable computing and/or video playing device, which may, for example, have one or more pieces of software installed thereon. In various embodiments, a Connected Computing Devices 120 is configured to at least temporarily couple to the Interactive Display Device 110 via a suitable Connector 122. In some embodiments, the connector comprises a universal connector-type configured to transmit power (e.g., via direct or alternating current), data (e.g., video, audio, networking data, USB, etc.), and other information via a single connector cable (e.g., USB-C, thunderbolt, etc.). In various other embodiments, the Connected Computing Device 120 is configured to couple a Pluggable Module 130 (e.g., via a suitable Cable 180) that has been inserted into a Computing Module Plug-In Slot 150 of the Interactive Display. In such embodiments, the Connector 122 may be configured to couple directly to a corresponding Connector 132 on the Pluggable Module 130.

Pluggable Module

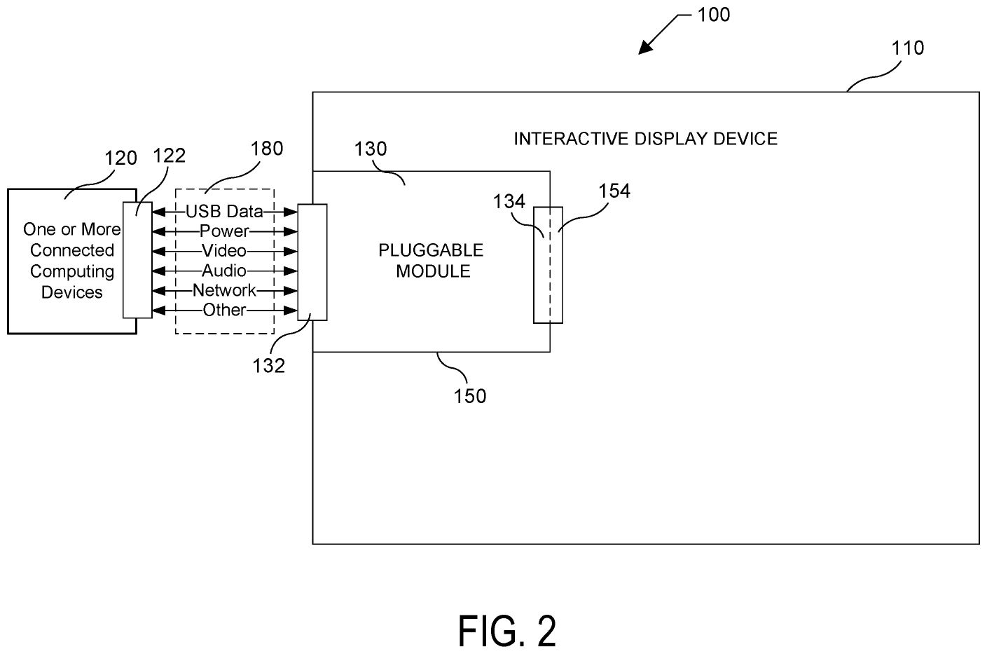

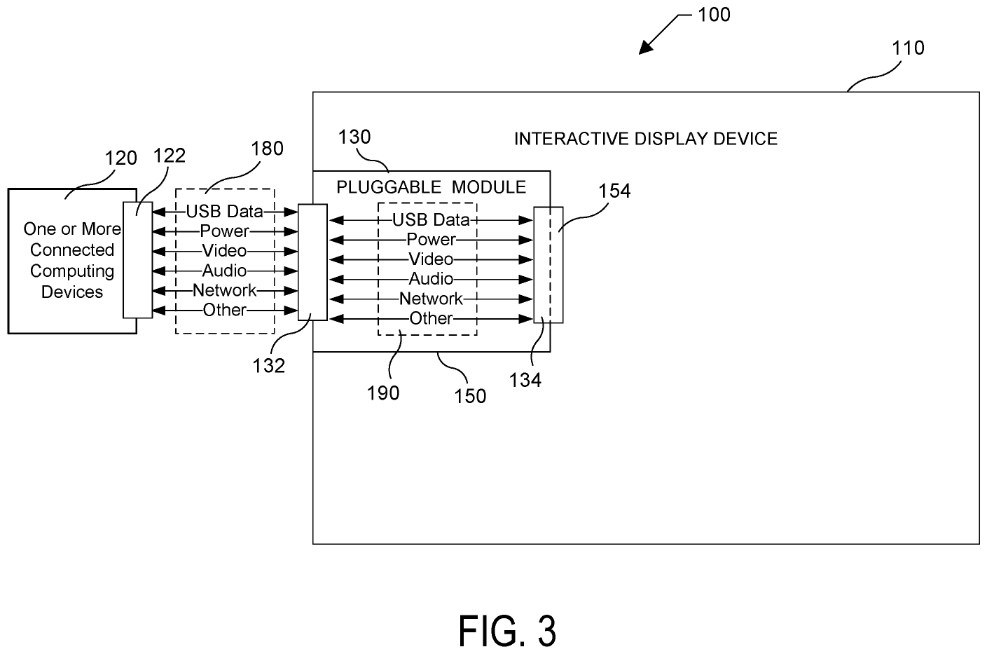

In various embodiments, a Pluggable Module 130 may be configured to expand the connectivity of an Interactive Display Device 110 by providing at least one additional Connector 132 via which a Connected Computing Device 120 can connect to the Interactive Display Device 110 for the purpose of transmitting data, power, etc. As may be understood from FIGS. 1-3, the Pluggable Module 130 may be configured to slot into a Computing Module Plug-In Slot 150 on an Interactive Display Device 110 (e.g., or other display device or any other suitable system that includes a Computing Module Plug-In Slot 150). The Pluggable Module 130 may, for example, have a form factor that corresponds to a slottable computing module geometry such as: (1) Open Pluggable Specification (OPS); (2) Smart Display Module (SDM); (3) Open Pluggable SPECIFICATION Plus (OPS+); and/or (4) Open Pluggable Specification-China (OPS-C); etc. The Pluggable Module 130 may, for example, comprise a housing having a form factor that corresponds to a suitable standard format computing module plugin. In this way, the Pluggable Module 130 may be configured to slot into a commonly available, universal Computing Module Plug-In Slot 150 in order to provide one or more additional inputs having a desired connector type to any device that contains a Computing Module Plug-In Slot 150 of the type that corresponds to the Pluggable Module 130.

As shown in these figures, the Pluggable Module 130 comprises a First Pluggable Module Connector 134 and a Second Pluggable Module Connector 132. The First Pluggable Module Connector 134 may comprise any suitable connector type such as, for example: (1) an 80 PIN OPS connector (e.g., a JAE TX25 plug connector and/or TX 24 receptacle or other suitable JAE connector type); (2) a PCI and/or PCI-e connector; and/or (3) any other suitable connector). As may be understood from the figures, the First Pluggable Module Connector 134 may be configured to engage with and connect to a Computing Module Plug-In Slot Connector 154 disposed on the Interactive Display Device 110 within the Computing Module Plug-In Slot 150. In this way, the Pluggable Module may be configured to receive data and/or power from the Interactive Display Device 110 (e.g., and/or provide power and/or data to the Interactive Display Device 110 when acting as a channel between the Interactive Display Device 110 and a Connected Computing Device 120), such as any data described herein.

As may be further understood from the figures and this disclosure, the Second Pluggable Module Connector 132 may comprise any suitable connector type (e.g., USB-C, thunderbolt, etc.). In particular embodiments, the Second Pluggable Module Connector 132 comprises a universal connector-type configured to transmit power, data (e.g., video, audio, networking data, USB, etc.), and other information via a single connector cable (e.g., Cable 180). In various embodiments, the Pluggable Module 130 is configured to convert one or more signals, pieces of data, currents, etc. between the First Pluggable Module Connector 134 and the Second Pluggable Module Connector 132. In this way, the system may be configured to enable a Connected Computing Device 120 to plug directly into the Interactive Display Device 110 via the Pluggable Module 130 (e.g., even if the Connector 122 is not directly compatible with the Computing Module Plug-In Slot Connector 154.

In various embodiments, the Pluggable Module may comprise one or more pieces of Circuitry 190 configured to transmit data, power, etc. between the First Pluggable Module Connector 134 and the Second Pluggable Module Connector 132. In particular embodiments, the Circuitry 190 comprises any suitable circuit board. In some embodiments, the Circuity 190 may include one or more processors and/or integrated circuits to enable such transmission.

In various embodiments, the one or more processors and/or integrated circuits are configured to detect one or more power requirements of the connected computing device and transfer power from the interactive display device to the connected computing device based on the one or more power requirements. In some embodiments, the one or more processors and/or integrated circuits are configured to detect one or more power requirements of the interactive display device and transfer power from the connected computing device to the interactive display device based on the one or more power requirements. In some embodiments, the one or more processors and/or integrated circuits are configured to detect a power down of the interactive display device and, in response, initiate a power down of the connected computing device according to a safe power down protocol. In still other embodiments, the one or more processors and/or integrated circuits are configured to detect a power down of the connected computing device and, in response, initiate a power down of the interactive display device according to a safe power down protocol.

In particular embodiments, the Circuity 190 is configured to map one more pins of the First Pluggable Module Connector 134 to one or more pins of the Second Pluggable Module Connector 132. For example, in various embodiments, at least some of the one or more pins of the First Pluggable Module Connector 134 may be configured to transmit power. These pins may, for example, be mapped (e.g., via the Circuitry 190) to one or more corresponding power pins of the Second Pluggable Module Connector 132. Similarly, at least some of the one or more pins of the First Pluggable Module Connector 134 may be configured to transmit USB data, control signals, audio, DisplayPort, HDMI, video data, etc. Each of these pins may in turn be mapped to one or more corresponding USB data/control signals/audio/DisplayPort/HDMI/video data/etc. pins of the Second Pluggable Module Connector 132. In this way, the Display System 100 is configured to provide connectivity to the Interactive Display Device 110 via a connector of the First Pluggable Module Connector 132 on the Pluggable Module 130, which is able to slot into the Interactive Display Device 110 by virtue of the computing module plug-in form factor. In various embodiments, the circuitry defines a high-speed data path between the first set of pins and the second set of pins. In a particular embodiment, the high-speed data path comprises a universal serial bus.

In various embodiments, unlike a traditional computing module plug-in, the Pluggable Module 130 is not configured to provide computing functionality to the Interactive Display Device 110 (e.g., absent any computing functionality provided by the One or More Connected Computing Devices 120 while the One or More Connected Computing Devices 120 are plugged into the Pluggable Module 130 via a suitable Cable 180).

### Illustrative Example

In a particular example implementation of a Pluggable Module 130 in the context of an Interactive Display System 100 described herein, a user may desire to connect a computing device (e.g., a Connected Computing Device 120, such as a laptop computer) to an Interactive Display Device 110 for use with the Interactive Display Device 110. The Connected Computing Device 120 may, for example, only have particular available connectors (e.g., only USB-C connectors). The Interactive Display Device 110 may, for example, lack any USB-C connectors (e.g., or lack any available USB-C Connectors). In this example, as long as the Interactive Display Device 110 has a Computing Module Plug-In Slot 150 (e.g., such as an OPS slot), the user can use the Pluggable Module 130 described herein to re-purpose the OPS slot as a convertor that enables direct USB-C connections to the Interactive Display Device 110. In this way, the Interactive Display Device 110 can provide, via the Pluggable Module 130 and a USB-C cable (180), to the Connected Computing Device 120: (1) power; (2) input data (e.g., inputs received on a touch display of the Interactive Display Device); (3) network data); and/or (4) any other suitable data or signals. The Connected Computing Device 120 may then provide, to the Interactive Display Device 110, via the USB-C Cable 180 and the Pluggable Module 130: (1) video data; (2) audio data; and/or (3) any other suitable data, signal, and/or power/current described herein.

The user may, for example: (1) insert the Pluggable Module 130 into the Computing Module Plug-In Slot 150 of an Interactive Display Device 110 such that the First Pluggable Module Connector 134 (e.g., first 80 PIN OPS connector) engages the Computing Module Plug-In Slot Connector 154 (e.g., second 80 IN OPS connector); and connect the Connected Computing Device 120 to the Second Pluggable Module Connector 132 (e.g., USB-C port/receptacle) on the Pluggable Module 130 via a USB-C cable (180).

The system described herein may enable a user to increase the connectivity of a ‘legacy’ display and/or interactive display (e.g., one with a functioning display screen and touch input device) to interact directly with other connected devices that have newer/different connector types. This may enable a user to increase the connectivity of their display device without having to replace the display device itself. This may further enable users to utilize higher power computing capability with their display device through a connected computer that a traditional OPS cannot provide.

### Example System Architecture

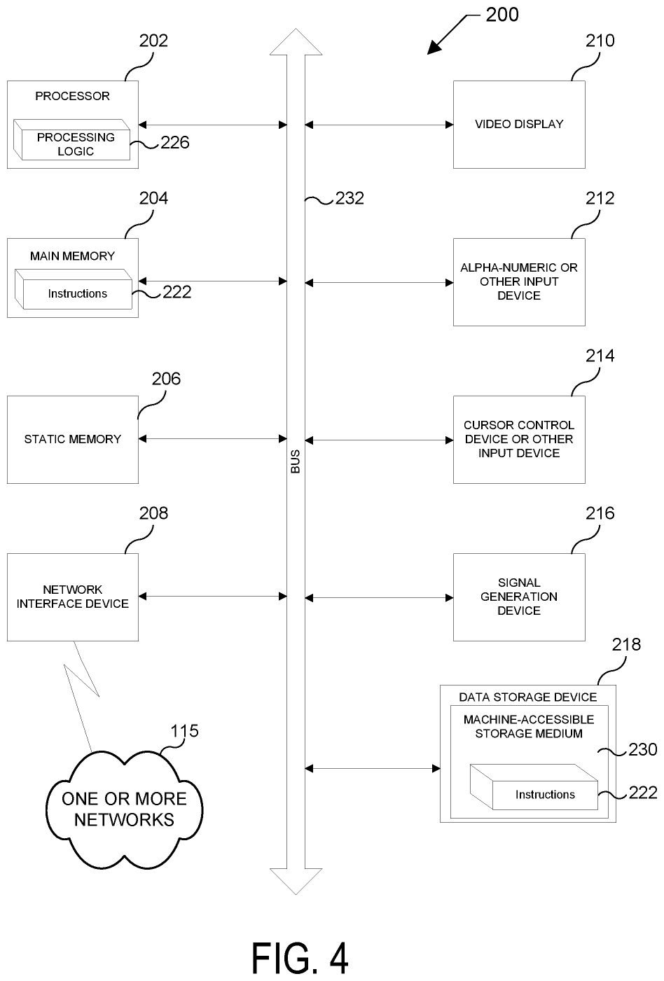

FIG. 4 illustrates a diagrammatic representation of a Computer Architecture 200 that can be used within the Interactive Display System 100, for example, as the One or More Connected Computing Devices 120. In particular embodiments, the Computer 200 may be suitable for use as a computer within the context of the Interactive Display System 100 that is configured to: (1) receive input from an interactive display device (e.g., such as the One or More Interactive Display Devices 110, etc.); (2) pass data (e.g., video data or any other suitable data) to the One or More Interactive Display Devices 110; (3) etc.

In particular embodiments, the Computer 200 may be connected (e.g., networked) to other computers in a LAN, an intranet, an extranet, and/or the Internet. As noted above, the Computer 200 may operate in the capacity of a server or a client computer in a client-server network environment, or as a peer computer in a peer-to-peer (or distributed) network environment. The Computer 200 may be a desktop personal computer (PC), a tablet PC, a set-top box (STB), a Personal Digital Assistant (PDA), a cellular telephone, a web appliance, a server, a network router, a switch or bridge, or any other computer capable of executing a set of instructions (sequential or otherwise) that specify actions to be taken by that computer. Further, while only a single computer is illustrated, the term “computer” shall also be taken to include any collection of computers that individually or jointly execute a set (or multiple sets) of instructions to perform any one or more of the methodologies discussed herein.

An exemplary Computer 200 includes a Processing Device 202 (e.g., one or more computer processors), a Main Memory 204 (e.g., read-only memory (ROM), flash memory, dynamic random access memory (DRAM) such as synchronous DRAM (SDRAM) or Rambus DRAM (RDRAM), etc.), a Static Memory 206 (e.g., flash memory, static random access memory (SRAM), etc.), and a Data Storage Device 218, which communicate with each other via a Bus 232.

The Processing Device 202 represents one or more general-purpose processing devices such as a microprocessor, a central processing unit, or the like. More particularly, the Processing Device 202 may be a complex instruction set computing (CISC) microprocessor, reduced instruction set computing (RISC) microprocessor, very long instruction word (VLIW) microprocessor, Scaler Board, or processor implementing other instruction sets, or processors implementing a combination of instruction sets. The Processing Device 202 may also be one or more special-purpose processing devices such as an application specific integrated circuit (ASIC), a field programmable gate array (FPGA), a digital signal processor (DSP), network processor, or the like. The Processing Device 202 may be configured to execute Processing Logic 226 for performing various operations and steps discussed herein.

The Computer 200 may further include a Network Interface Device 208. The Computer 200 also may include a Video Display Unit 210 (e.g., a liquid crystal display (LCD), LED display, OLED display, plasma display, a projector, a cathode ray tube (CRT), any suitable display described herein, or any other suitable display), an alphanumeric or other input device 212 (e.g., a keyboard), a cursor control or other Input Device 214 (e.g., a mouse, stylus, pen, touch-sensitive input device, Touch Input Device 105, etc.), and a Signal Generation Device 216 (e.g., a speaker).

The Data Storage Device 218 may include a non-transitory Computer-accessible Storage Medium 230 (also known as a non-transitory computer-readable storage medium or a non-transitory computer-readable medium) on which is stored one or more sets of instructions (e.g., Software 222) embodying any one or more of the methodologies or functions described herein. The Software 222 may also reside, completely or at least partially, within the Main Memory 204 and/or within the Processing Device 202 during execution thereof by the Computer 200—the Main Memory 204 and the Processing Device 202 also constituting computer-accessible storage media. The Software 222 may further be transmitted or received over a Network 115 via a Network Interface Device 208.

While the Computer-accessible Storage Medium 230 is shown in an exemplary embodiment to be a single medium, the term “computer-accessible storage medium” should be understood to include a single medium or multiple media (e.g., a centralized or distributed database, and/or associated caches and servers) that store the one or more sets of instructions. The term “computer-accessible storage medium” should also be understood to include any medium that is capable of storing, encoding or carrying a set of instructions for execution by the computer and that cause the computer to perform any one or more of the methodologies of the present invention. The term “computer-accessible storage medium” should accordingly be understood to include, but not be limited to, solid-state memories, optical and magnetic media, etc.

### CONCLUSION

Many modifications and other embodiments of the invention will come to mind to one skilled in the art to which this invention pertains having the benefit of the teachings presented in the foregoing descriptions and the associated drawings. While this specification contains many specific embodiment details, these should not be construed as limitations on the scope of any invention or of what may be claimed, but rather as descriptions of features that may be specific to particular embodiments of particular inventions. Certain features that are described in this specification in the context of separate embodiments may also be implemented in combination in a single embodiment. Conversely, various features that are described in the context of a single embodiment may also be implemented in multiple embodiments separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination. For example, particular embodiments referring to one or more interactive display devices may include a single interactive display device, while still other embodiments referring to an interactive display device may include a plurality of interactive display devices.

Similarly, while operations are depicted in the drawings in a particular order, this should not be understood as requiring that such operations be performed in the particular order shown or in sequential order, or that all illustrated operations be performed, to achieve desirable results. Additionally, while some steps may be described as occurring in response to (e.g., or at least partially in response to) particular other steps, it should be understood that, in other embodiments, such steps may occur independent of (e.g., or coincident with) one another. In certain circumstances, multitasking and parallel processing may be advantageous. Moreover, the separation of various system components in the embodiments described above should not be understood as requiring such separation in all embodiments, and it should be understood that the described program components and systems may be generally integrated together in a single software product or packaged into multiple software products.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for the purposes of limitation.

What is claimed is:

1. A pluggable module for converting a first connector type to a second connector type, the pluggable module comprising:
a housing dimensioned to correspond to a computing module plug-in slot of a display device;
a first connector of the first connector type disposed on the housing and configured to engage with a corresponding connector disposed in the computing module plug-in slot, wherein the first connector has a first set of pins according to the first connector type;
a second connector of the second connector type disposed on the housing such that when the pluggable module is inserted into the computing module plug-in slot of the display device, the second connector is accessible and configured to enable a user to plug a cable that corresponds to the second connector type into the second connector to facilitate a direct connection between the pluggable module and a connected computing device via the cable, wherein the second connector has a second set of pins according to the second connector type; and
circuitry configured to map the first set of pins to the second set of pins.

2. The pluggable module of claim 1, wherein the computing module plug-in slot is a standard format computing module plug-in slot selected from the group consisting of:
(1) Open Pluggable Specification (OPS);
(2) Smart Display Module (SDM);
(3) Open Pluggable Specification Plus (OPS+); and
(4) Open Pluggable Specification-China (OPS-C).

3. The pluggable module of claim 1, wherein the housing has a standard slottable computing module geometry that corresponds to a slottable computing module geometry selected from the group consisting of:
(1) Open Pluggable Specification (OPS);
(2) Smart Display Module (SDM);
(3) Open Pluggable Specification Plus (OPS+); and
(4) Open Pluggable Specification-China (OPS-C).

4. The pluggable module of claim 1, wherein the pluggable module does not provide computer functionality to the display device when inserted into the computing module plug-in slot of the display device.

5. The pluggable module of claim 1, wherein the circuitry maps at least one first pin from the first connector to at least one second pin of the second connector.

6. The pluggable module of claim 5, wherein the circuitry is configured to transfer power between the at least one first pin and the at least on second pin such that the circuitry provides power a connected computing device connected to the pluggable module via the second connector.

7. The pluggable module of claim 6, wherein the circuitry is configured to transfer one or more pieces of data between the first connector and the second connector, the one or more pieces of data including one or more pieces of data selected from the group consisting of:
video data;
audio data;
network data; and
USB data.

8. The pluggable module of claim 7, wherein the second connector is selected from the group consisting of:
a USB-C connector; and
a thunderbolt connector.

9. The pluggable module of claim 7, wherein the first connector is selected from the group consisting of:
an OPS 80-PIN connector;
a PCI-e connector.

10. A pluggable converter module for converting a first connector type into a second connector type, the pluggable module comprising:
a housing dimensioned to correspond to a computing module plug-in slot of an interactive touch display device;
a first connector of the first connector type disposed on the housing and configured to engage with a corresponding connector disposed in the computing module plug-in slot of the interactive touch display device, wherein the first connector has a first set of pins according to the first connector type;
a second connector of the second connector type disposed on the housing such that when the pluggable module is inserted into the computing module plug-in slot of the interactive touch display device, the second connector is accessible and configured to enable a user to plug a cable that corresponds to the second connector type into the second connector to facilitate a direct connection between the pluggable module and a connected computing device via the cable, wherein the second connector has a second set of pins according to the second connector type; and
circuitry configured to map the first set of pins to the second set of pins, wherein the pluggable converter module is configured to pass video, sound, power, and USB signals between the first connector type and the second connector type.

11. The pluggable converter module of claim 10, wherein the pluggable converter module is configured to pass the video, sound, power, and USB signals from the connected computing device to the interactive touch display device via the first connector, the pluggable converter module, and the second connector.

12. The pluggable convertor module of claim 10, wherein the circuitry defines a high-speed data path between the first set of pins and the second set of pins

13. The pluggable convertor module of claim 12, wherein the high-speed data path comprises a universal serial bus.

14. The pluggable convertor module of claim 10, wherein:
the pluggable convertor module comprises a controller configured to detect a power requirement for the connected computing device; and
the pluggable converter module is configured to pass power from the interactive display device to the connected computing device based on the power requirement.

15. The pluggable convertor module of claim 10, further comprising an integrated circuit configured to detect a power down of the interactive touch display device and, in response to detecting the power down, initiating a power down of the connected computing device according to a safe power down protocol.

16. The pluggable convertor module of claim 10, wherein the second connector type is one of a USB-C connector and a thunderbolt connector.

17. A method of connecting an interactive display device to a connected computing device via a cable corresponding to a connector type that the interactive display device does not comprise, the method comprising:
providing an interactive display device defining a computing module plug-in slot dimensioned to receive a computing module plug-in of a first type and comprising a computing module plug-in slot connector disposed in the computing module plug-in slot;
proving a pluggable module having a geometry that corresponds to the computing module plug-in of the first type and comprising:
a first pluggable module connector that corresponds to the computing module plug-in slot connector and is disposed on a first side of the pluggable module;
a second pluggable module connector of the connector type disposed on a second side of the pluggable module, the second side of the pluggable module opposing the first side of the pluggable module; and
circuitry that maps the first pluggable module connector to the second pluggable module connector such that the circuitry is configured to transmit video data, audio data, network data, power, and USB data between the first pluggable module connector and the second pluggable module connector;
slotting the pluggable module into the computing module plug-in slot such that the first side of the pluggable module enters the computing module plug-in slot first and the computing module plug-in slot connector engages with the first pluggable module connector;
providing the cable corresponding to the connector type; and
directly connecting the connecting computing device to the interactive display device by directly connecting the connected computing device to the second pluggable module connector using the cable such that the video data, audio data, network data, power, and USB data pass from the connecting computing device to the interactive display device by via the pluggable module and the cable.

18. The method of claim 17, wherein:
the cable comprises a USB-C cable;
the second pluggable module connector comprises a USB-C connector;
the computing module plug-in of the first type comprises Open Pluggable Specification;
the computing module plug-in slot connector comprises an OPS 80-PIN connector; and
the first pluggable module connector comprises a corresponding OPS 80-PIN connector.

19. The method of claim 17, wherein the circuitry maps at least one first pin from the first pluggable module connector to at least one second pin of the second pluggable module connector.

20. The method of claim 19, wherein the circuitry is configured to transfer at least one of the video data, the audio data, the network data, the power, and the USB data between the at least one first pin and the at least on second pin such that the circuitry provides a direct connection between the connected computing device and the interactive display device.
